(19) United States
(12) Patent Application Publication
(10) Pub. No.: US 2009/0271579 A1
(43) Pub. Date: Oct. 29, 2009

(54) Storage subsystem and storage system

(75) Inventor: Junji Ogawa, Sagamihara (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/213,955

(22) Filed: Jun. 26, 2008

(30) Foreign Application Priority Data
Apr. 24, 2008 (JP) 2008-114451

(51) Int. Cl. G06F 12/00

(52) U.S. Cl. 711/159

(57) ABSTRACT

Provided is a storage subsystem that can reflect, when merging storage update information and local update information, those two kinds of update information in relevant volumes without overlapping the storage update information and the local update information. When reflecting update information in a storage subsystem 10 and update information in a mobile terminal 14 in relevant volumes, the storage subsystem 10: compares local update information and storage update information based on bitmaps; when both the relevant storage destinations overlap, selects a volume update pattern serving as a storage destination different from the storage destination for the local update information from among plural volume update patterns; and stores the storage update information in a storage area corresponding to the selected volume update pattern, and the mobile terminal 14 stores the storage update information in local storage 102.

### CROSS-REFERENCES TO RELATED APPLICATIONS

This application relates to and claims priority from Japanese Patent Application No. 2008-114451, filed on Apr. 24, 2008, the entire disclosure of which is incorporated herein by reference.

### BACKGROUND

The invention relates generally to a storage subsystem and a storage system, and particularly relates to a technique of, when updating a file system accessed by a mobile terminal or a server, or a host computer, reflecting update information from each device in the file system.

A storage system has been proposed in which: plural computers alternately used by plural users and a storage are connected by fibre channels; dedicated logical volumes for the users are defined in the storage; when a user uses a computer, the computer accesses a dedicated logical volume to boot up an operating system (OS) via the logical volume, leading to authentication of the user; and the dedicated logical volume for the user is to be allowed to access only the computer used by the user (see JP2001-075853 A).

### SUMMARY

Incidentally, in a storage system composed of a mobile terminal and a storage in a data center, when an offline update of a local disk in the mobile terminal and an update of a volume on the storage device side both have occurred, both the updates need to be reflected in a file system.

However, where the storage in the data center is block storage, there may be a conflict between an update in a file system conducted in a mobile terminal, and an update in a storage device. In this case, synchronization effected with a volume copy function on the storage side is executed, so a portion of an update conducted by an application server on the storage device side is overwritten.

In light of the above, the present invention has been made to provide a storage subsystem that can reflect, when merging storage update information and local update information, those two kinds of update information in relevant volumes without overlapping the storage update information and the local update information.

In order to attain the above object, the invention is characterized in that, when performing volume merge, in which storage update information as a result of processing in a storage subsystem and local update information as a result of processing in a mobile terminal are reflected in relevant volumes, the storage update information is stored in a storage area serving as a storage destination different from a storage destination for the local update information.

Employing the above configuration, when merging the storage update information and the local update information, those two kinds of update information can be reflected in the relevant volumes without overlapping the storage update information and the local update information.

According to the invention, when merging storage update information and local update information, those two kinds of update information can be reflected in relevant volumes without overlapping the storage update information and the local update information.

Other aspects and advantages of the invention will be apparent from the following description and the appended claims.

### BRIEF DESCRIPTION OF THE DRAWINGS

FIG. 1 is a block structural diagram of a storage system showing an embodiment of the invention.

FIG. 2 is a block structural diagram of a storage subsystem.

FIG. 3 is a block structural diagram of memory in a storage subsystem.

FIG. 4 is a block structural diagram of an application server.

FIG. 5 is a block structural diagram of memory in an application server.

FIG. 6 is a block structural diagram of a mobile terminal.

FIG. 7 is a block structural diagram of memory in a mobile terminal.

FIG. 8 is a flowchart explaining the effect of a first embodiment.

FIG. 9 is a structural explanatory diagram of an update position policy.

FIG. 10 is a flowchart explaining synchronization processing of an application server and a mobile terminal.

FIG. 11 is a diagram explaining the relationship between a file system and volumes in the first embodiment.

FIG. 12 is a flowchart explaining the effect of a second embodiment.

FIG. 13 is a diagram explaining the relationship between a file system and a volume in the second embodiment.

FIG. 14 is a flowchart explaining the effect of a third embodiment.

FIG. 15 is a diagram explaining the relationship between a file system and a volume in the third embodiment.

### DETAILED DESCRIPTION OF PREFERRED EMBODIMENTS

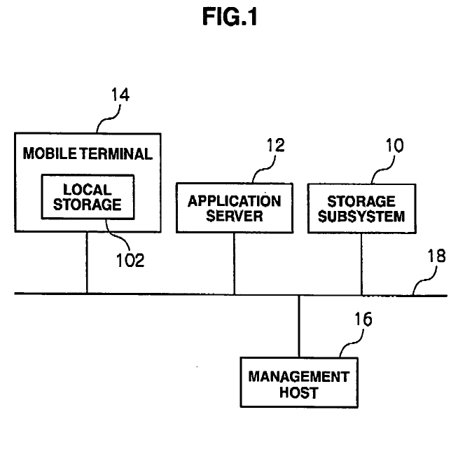

An embodiment of the invention will be described below with reference to the accompanying drawings. FIG. 1 is a block structural diagram of a storage system showing the embodiment of the invention. In FIG. 1, the storage system includes a storage subsystem 10, an application server 12, a mobile terminal 14, and a management host 16. The storage subsystem 10, the application server 12, the mobile terminal 14, and the management host 16 are connected to one another via a communication network 18.

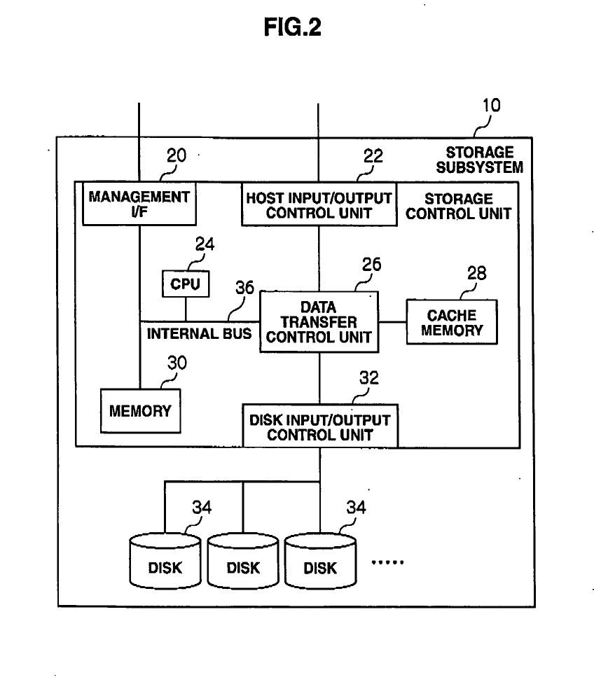

The storage subsystem 10 is located in, e.g., a data center, and includes: a storage control unit, which is composed of a management interface (I/F) 20, a host input/output control unit 22, a CPU (Central Processing Unit) 24, a data transfer control unit 26, cache memory 28, memory 30, and a disk input/output control unit 32; and plural disks (hard disk drives) 34 as memory apparatuses or storages, which are composed of plural memory devices, as shown in FIG. 2. The disks 34 constitute volumes including physical volumes and logical volumes, and a file system is established on the volumes. This file system constitutes files or directories using, e.g., a group of sectors. In a part of plural files or directories, plural volume update patterns are set as storage destination candidates for storage update information created as a result of application execution.

The management interface 20 is connected to the management host 16 via the communication network 18. The host input/output control unit 22 is connected to the application server 12 and the mobile terminal 14 via the communication network 18. The disk input/output control unit 32 is connected to each of the disks 34.

The management interface 20 controls data exchange and communication with the management host 16, and the host input/output control unit 22 controls information exchange and communication with the application server 12 and the mobile terminal 14. The CPU 24 is connected to the management interface 20, the memory 30, and the data transfer control unit 26 via an internal bus 36, executes various kinds of processing in accordance with the programs stored in the memory 30, and controls the entire storage control unit based on the processing results. The data transfer control unit 26 controls data transfer in the storage control unit, and the cache memory 28 temporarily retains data associated with the data transfer. The disk input/output control unit 32 controls data input/output to/from each of the disks 34 and data input/output to/from the data transfer control unit 26.

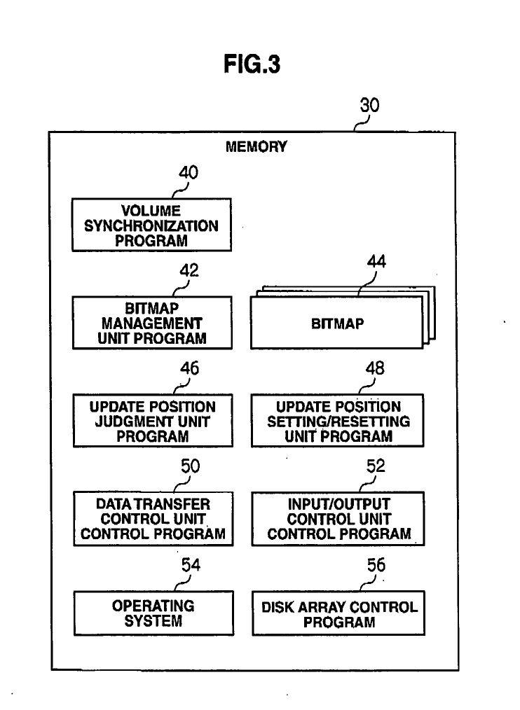

The memory 30 stores, as shown in FIG. 3, a volume synchronization program 40, a bitmap management unit program 42, bitmaps 44, an update position judgment unit program 46, an update position setting/resetting unit program 48, a data transfer control unit control program 50, an input/output control unit control program 52, an operating system 54, and a disk array control program 56.

The volume synchronization program 40 is a program for synchronizing local storage 102 in the mobile terminal 14 and the storage subsystem 10 to execute update processing in an online state. The bitmaps 44 are maps corresponding to a memory area of the disks 34, and each of the bitmaps 44 is composed of a memory area of, e.g., n×n bits. When copy is performed to a volume corresponding to a predetermined memory area forming one of the bitmaps 44, “1” is set in the relevant bitmap corresponding to that memory area. The status of the bitmap 44 is managed by the bitmap management unit program 42.

The update position judgment unit program 46 is a program for judging, when synchronizing the local storage 102 in the mobile terminal 14 and the storage subsystem 10 to execute update processing in an online state, whether or not the relevant update position is correct. The update position setting/resetting unit program 48 is a program for setting an update position in the storage subsystem 10 and resetting an update position in the storage subsystem 10 when the update position is incorrect. The data transfer control unit control program 50 is a program for the control of the data transfer control unit 26, and the input/output control unit control program 52 is a program for the control of the host input/output control unit 22. The operating system 54 is a program for being used for the operation of the CPU 24, and the disk array control program 56 is a program for the control of the disk input/output control unit 32.

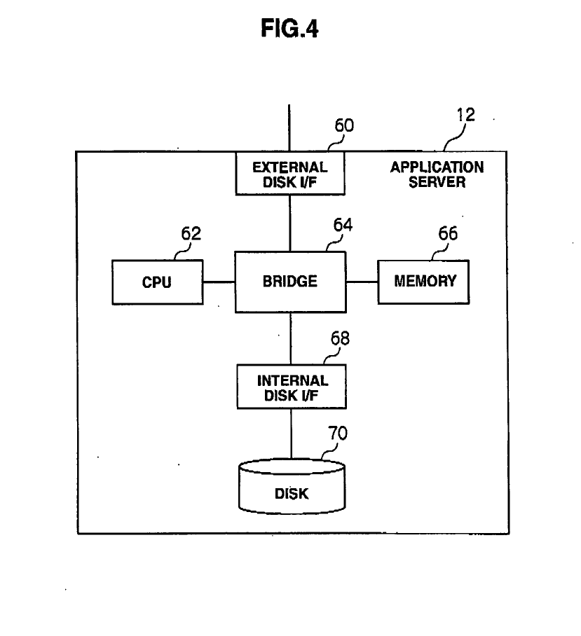

The application server 12 is configured to include an external disk interface (I/F) 60, a CPU 62, a bridge 64, memory 66, an internal disk interface (I/F) 68, and a disk 70, as shown in FIG. 4. The external disk interface 60 is connected to the communication network 18, and controls data exchange and communication with the mobile terminal 14 and the storage subsystem 10. The CPU 62 controls the entire application server 12, and executes various kinds of control and calculation processing in accordance with the programs stored in the memory 66. The bridge 64 controls data transfer in the application server 12. The internal disk interface 68 controls data input/output to/from the bridge 64, and performs data read/write access to/from the disk 70.

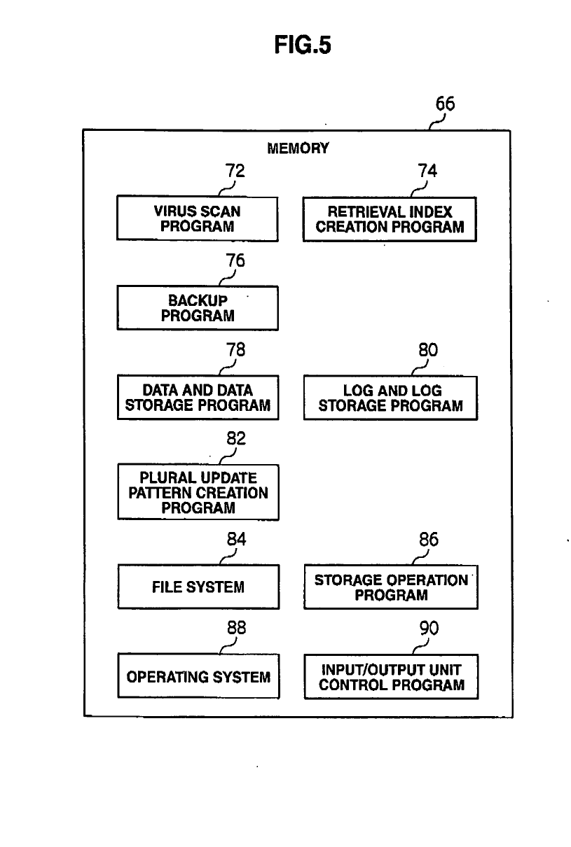

The memory 66 stores, as shown in FIG. 5, a virus scan program 72, a retrieval index creation program 74, a backup program 76, a data and data storage program 78, a log and log storage program 80, a plural update pattern creation program 82, a file system 84, a storage operation program 86, an operating system 88, and an input/output unit control program 90.

The virus scan program 72 is a program, serving as an application, for performing a virus scan on the storage subsystem 10, and the retrieval index creation program 74 is a program, serving as an application, for executing retrieval processing on the storage subsystem 10. The backup program 76 is a program, serving as an application, for executing backup processing on the storage subsystem 10. The data and data storage program 78 is a program relating to data and data storage. The log and log storage program 80 is a program relating to logs and log storage. The plural update pattern creation program 82 is a program for creating plural update patterns.

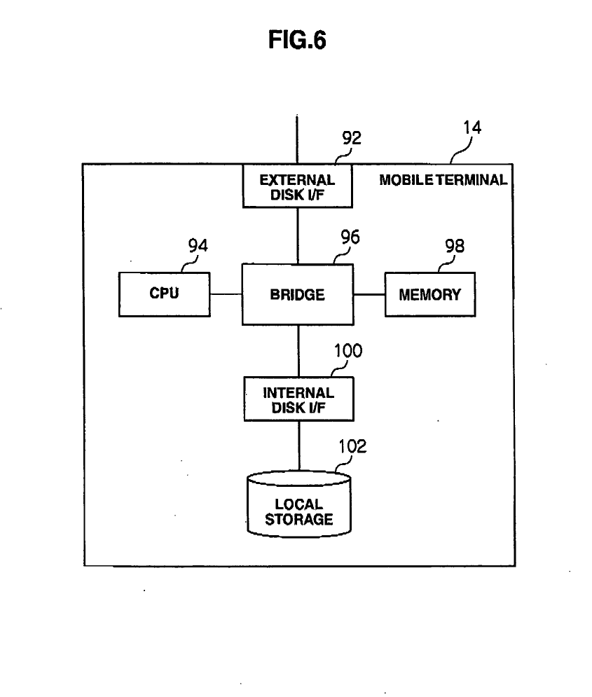

The mobile terminal 14 is configured to include an external disk interface (I/F) 92, a CPU 94, a bridge 96, memory 98, an internal disk interface (I/F) 100, and local storage 102, as shown in FIG. 6.

The external disk interface 92 is connected to the communication network 18, and controls data exchange and communication with the application server 12 and the storage subsystem 10. The CPU 94 controls the entire mobile terminal 14, and executes various kinds of control and calculation processing in accordance with the programs stored in the memory 98. The bridge 96 controls data transfer in the mobile terminal 14. The internal disk interface 100 controls data input/output to/from the bridge 96, and performs data read/write access to/from the local storage 102.

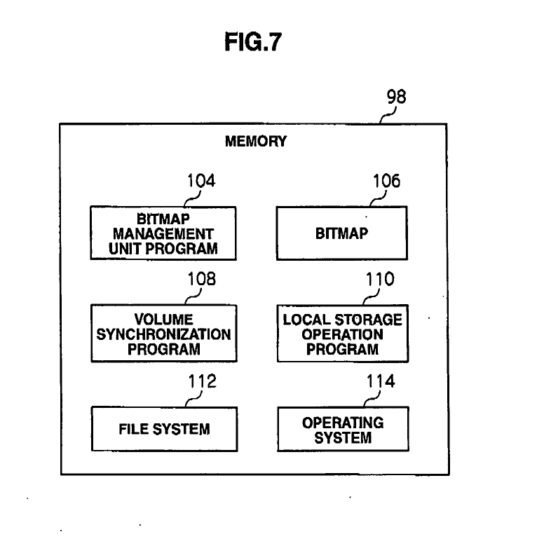

The memory 98 stores a bitmap management unit program 104, a bitmap 106, a volume synchronization program 108, a local storage operation program 110, a file system 112, and an operating system 114, as shown in FIG. 7.

The bitmap management unit program 104 is a program for managing the bitmap 106. The bitmap 106 is a map made to correspond to a memory area of the local storage 102, and is composed of, e.g., a memory area of n×n bits. When copy is conducted to the volume corresponding to a predetermined memory area forming the bitmap 106, “1” is set in the bitmap corresponding to that memory area. The status of the bitmap 106 is managed by the bitmap management unit program 104. The volume synchronization program 108 is a program for synchronizing the local storage 102 in the mobile terminal 14 and the storage subsystem 10 to execute update processing in an online state. The local storage operation program 110 is a program for operating the local storage 102.

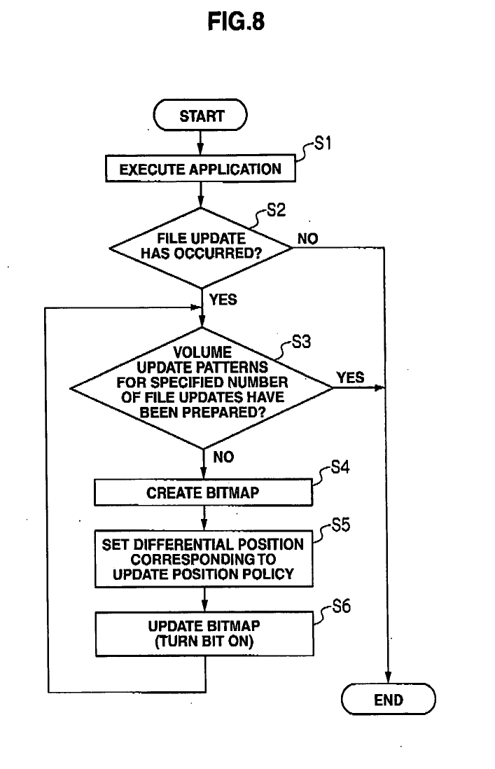

Next, the effect of the application server 12 will be described with reference to the flowchart of FIG. 8. In this embodiment, in the file system, an area (directory) is prepared in advance to be used on the storage subsystem 10 side, and a lock for the area is acquired; for that directory, plural change patterns in a volume (volume change patterns), which indicate the same updates in the file system, are prepared; and when performing volume merge, an appropriate volume change pattern not causing inconsistency with respect to the update in the mobile terminal 14 is selected to conduct the merge.

Specifically, the CPU 62 in the application server 12 executes an application based on one of, e.g., the virus scan program 72, the retrieval index creation program 74, and the backup program 76 (S1), and judges whether or not a file update has occurred when the application is completed (S2). If a file update has not occurred, the CPU 62 terminates the processing in this routine, and if a file update has occurred, the CPU 62 judges whether or not the volume update patterns for a specified number of file updates have been prepared (S3).

If the CPU 62 determines that the volume update patterns for a specified number of file updates have been prepared in that step, it terminates the processing in this routine, and if the CPU 62 determines that the volume update patterns for a specified number of file updates have not been prepared, it creates a bitmap for creation of the volume update patterns for a specified number of file updates (S4).

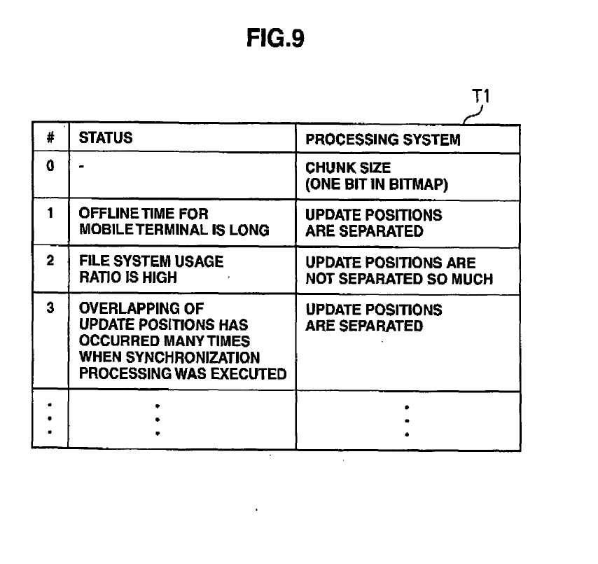

Then, the CPU 62 sets a differential position depending on an update position policy (S5). At this point, the CPU 62 retrieves an update position policy table T1 stored in the memory 66 in FIG. 9, and employs a processing system depending on the update position policy based on the retrieval. For example, in the case of item #0, there is no status information, so a processing system in which update positions are separated from one another by at least a chunk size (for one bit in a bitmap) is adopted. In the case of item #1, the relevant status information shows that the offline time of the mobile terminal 14 is long, so a processing system in which update positions are separated from one another is adopted. In the case of item #2, the relevant status information shows that the file system usage ratio is high, so a processing system in which update positions are not separated much from one another is adopted. In the case of item #3, the relevant status information shows that overlapping of update positions has occurred many times when synchronization processing was executed, so a processing system in which update positions are separated from one another is adopted.

Next, the CPU 62 updates the bitmap, turns the bit corresponding to the prepared volume update pattern ON, and returns to the processing in step S3. The CPU 62 repeats the processing in steps S3 through S6 until the completion of creation of the volume update patterns for a specified number of file updates. As a result, the volume update patterns for a specified number of file updates can be prepared.

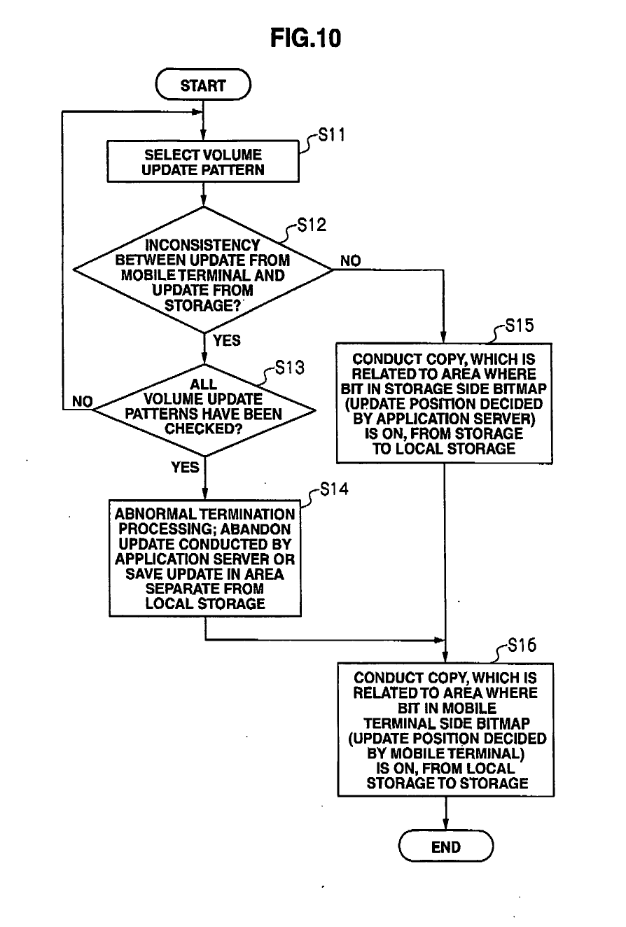

Then, synchronization processing in the storage subsystem 10 will be described with reference to the flowchart of FIG. 10. First, the CPU 24 in the storage subsystem 10 selects an arbitrary volume update pattern from among the volume update patterns for a specified number of file updates (S11), and judges, with respect to the selected volume update pattern, whether or not there is inconsistency between the update from the mobile terminal 14 and the update from the application server 12 based on the bitmap in the mobile terminal 14 and the bitmap 44 in the storage subsystem 10 (S12). If the CPU 24 determines that there is inconsistency, the CPU 24 judges whether or not all the volume update patterns for a specified number of file updates have been checked (S13). If the CPU 24 determines that all the volume update patterns for a specified number of file updates have not been checked, the CPU 24 returns to the processing in step S11, and repeats the processing in steps S11 through S13 until all the volume update patterns for a specified number of file updates are checked.

If there is inconsistency, and if all the volume update patterns for a specified number of file updates are checked, the CPU 24 proceeds to abnormal termination processing for abandoning the update (update information) conducted by the application server 12 or for saving the update in a separate area from the local storage 102, and moves to the processing in step S16 (S14). More specifically, if there is inconsistency, it is impossible for data copy from the storage subsystem 10 to the local storage 102 to be performed (effective update information in the local storage 102 will be abandoned). The update information from the application server 12 is copied, as storage update information, to a separate area from the local storage 102, such as other storage managed by the management host 16.

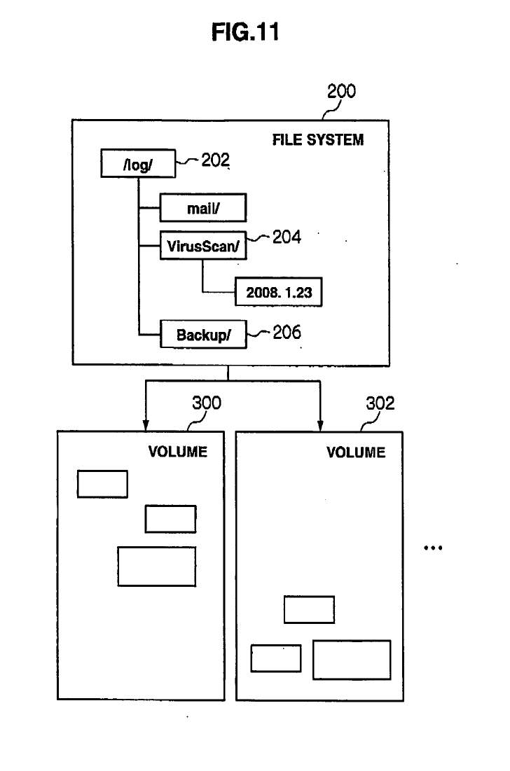

Meanwhile, if the CPU 24 determines that there is no inconsistency between the update from the mobile terminal 14 and the update from the application server 12, the CPU 24 conducts copy, which is related to the area where the bit in the storage side bitmap (update position from the application server 12) is ON, of the relevant update information, serving as storage update information, from the storage subsystem 10 to the local storage 102 (S15). Then, the CPU 24 conducts copy, which is related to the area where the bit in the mobile terminal side bitmap (update position from the mobile terminal 14) is ON, of the relevant update information, serving as local update information, from the local storage 102 to the storage subsystem 10 (S16), and terminates the processing in this routine. FIG. 11 shows the relationship at this point between the file system and volumes.

FIG. 11 shows the state where, when a virus scan 204 and a backup 206, for a log 202 in the file system 200, are executed in accordance with an application, volumes 300 and 302 respectively store storage update information and local update information at specified update positions (storage areas).

According to this embodiment, when conducting volume merge in which local update information and storage update information are reflected in the volumes, the storage subsystem 10 compares the local update information and the storage update information based on the bitmaps; when both the relevant storage destinations overlap, selects a volume update pattern serving as a storage destination different from the storage destination for the local update information from among plural volume update patterns; and stores the storage update information in a storage area corresponding to the selected volume update pattern. Meanwhile, when conducting volume merge, the mobile terminal 14 stores the storage update information in the storage area in the local storage (local volume) 102 which corresponds to the storage area for the storage update information in the storage subsystem 10, and so can store (reflect) the local update information and the storage update information in each of the specified storage areas without the conflict between the local update information and the storage update information. As a result, the results obtained through various operations, which are performed on the storage subsystem 10 side, such as a virus scan, backup, and retrieval index creation, can be stored for later use.

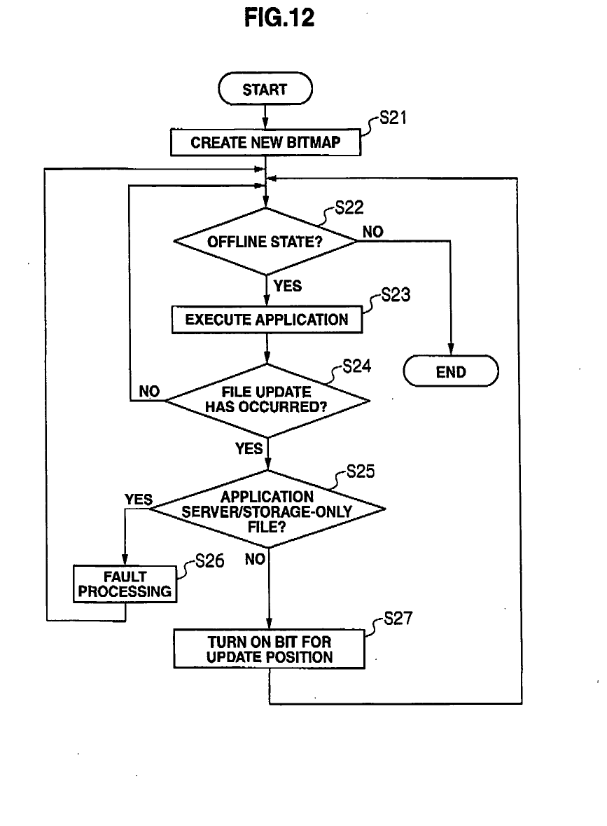

Next, the effect of a second embodiment will be described with reference to the flowchart of FIG. 12. In this embodiment, a file having an attribute of not changing a storage position is prepared in advance for updates on the storage subsystem 10 side, and updates are performed in the file, leading to no influence on the other files or directories in a file system.

First, the CPU 94 in the mobile terminal 14 creates a new bitmap 106 (S21), and judges whether or not it is in an offline state or not (S22). If it is not in an offline state, i.e., it is in an online state, the CPU 94 terminates the processing in this routine, and if it is in an offline state, the CPU 94 executes an application (S23).

After the completion of the application processing, the CPU 94 judges whether or not a file update has occurred (S24). If a file update has not occurred, the CPU 94 returns to the processing in step S22, and if a file update has occurred, the CPU 94 judges whether or not the update is an update of an application server/storage-specific file (S25). If the update is an update of an application server/storage-specific file, the CPU 94 recognizes that: a lock on the file system does not operate normally; and an update of a file that should not be updated is to be performed, and executes fault processing for abandoning the update (S26), and then returns to the processing in step S22.

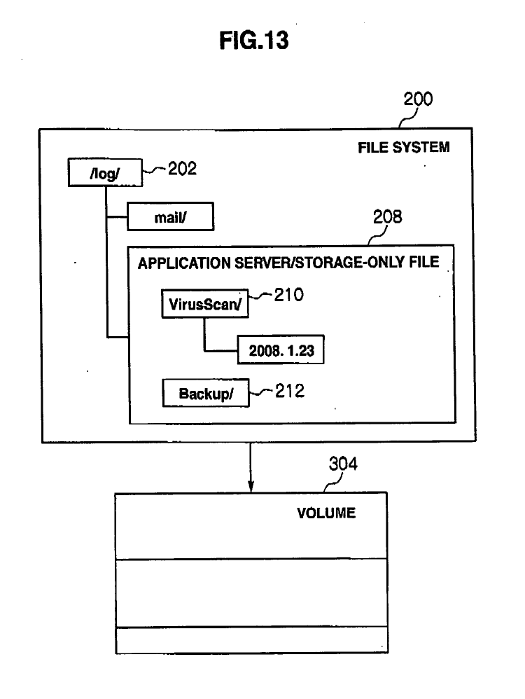

Meanwhile, if the CPU 94 determines that an update file is not an application server/storage-specific file, the CPU 94 turns on the bit at the update position ON (S27), and returns to the processing in step S22. FIG. 13 shows the relationship at this point between the file system and a volume.

FIG. 13 shows the state where, when a virus scan 210 and a backup 212, for the log 202 in the file system 200, are executed in an application server/storage-specific file 208, a volume 304 stores update information (storage update information) at a specified update position (storage area).

According to this embodiment, when conducting volume merge in which the local update information associated with the processing in the mobile terminal 14 and the storage update information associated with the processing in the storage subsystem 10 are reflected in the relevant volumes, the storage subsystem 10 stores the storage update information in a storage area serving as a storage destination different from the storage destination for the local update information, and so can store the local update information and the storage update information in specified storage areas without the conflict between the local update information and the storage update information. As a result, the results obtained through various operations, which are performed on the storage subsystem 10 side, such as a virus scan, backup, and retrieval index creation, can be stored in the storage subsystem 10 for later use.

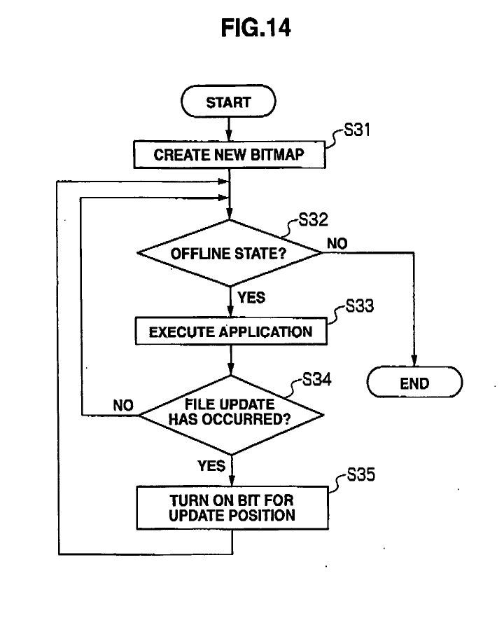

Next, the effect of a third embodiment will be described with reference to the flowchart of FIG. 14. First, the CPU 94 in the mobile terminal 14 creates a new bitmap 106 (S31), and judges whether or not it is in an offline state (S32). If it is not in an offline state, i.e., it is in an online state, the CPU 94 terminates the processing in this routine, and if it is in an offline state, the CPU 94 executes an application (S33).

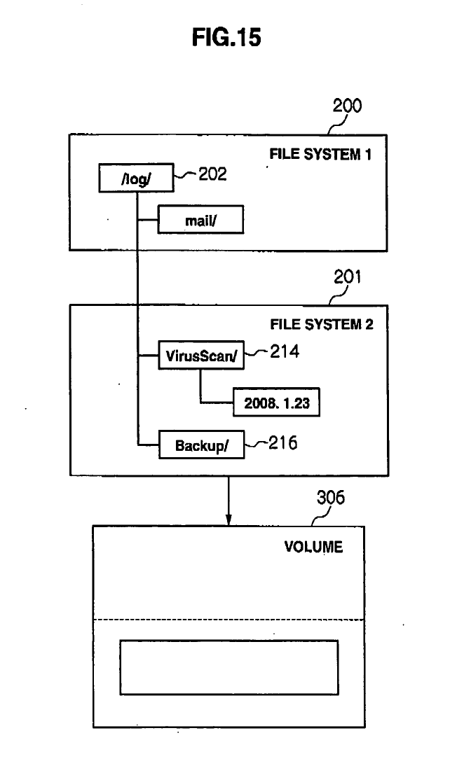

After the completion of the application execution, the CPU 94 judges whether or not a file update has occurred (S34). If a file update has not occurred, the CPU 94 returns to the processing in step S32, and if a file update has occurred, the CPU 94 turns the bit for the update position ON (S35), and returns to the processing in step S32. FIG. 15 shows the relationship involved in this processing between the file system and a volume.

FIG. 15 shows the state where, when a virus scan 214 and a backup 216, for the log 202 in the file system 200, are executed, a volume 306 stores storage update information (storage update information) at a specified update position (storage area).

According to this embodiment, when conducting volume merge, the storage subsystem 10 stores the storage update information in a file system different from the file system including the storage destination for the local update information, and so can store the local update information and the storage update information in specified storage areas without the conflict between the local update information and the storage update information. As a result, the results obtained through various operations, which are conducted on the storage subsystem 10 side, such as a virus scan, backup, and retrieval index creation, can be stored in the storage subsystem 10 for later use.

Note that the storage subsystem 10 can execute the processing in each of the embodiments in parallel.

The mobile terminal 14 has been described in each of the above embodiments. However, instead of the mobile terminal 14, a host computer that exchanges information with the storage subsystem 10 via the communication network 18 may be used, and also, both the mobile terminal 14 and the host computer may be used as pieces of equipment that utilize the storage subsystem 10.

While the invention has been described with respect to a limited number of embodiments, those skilled in the art, having benefit of this disclosure, will appreciate that other embodiments can be devised that do not depart from the scope of the invention as disclosed herein. Accordingly, the scope of the invention should be limited only by the attached claims.

What is claimed is:

1. A storage subsystem comprising:
a memory apparatus being composed of plural memory devices; and
a storage control unit storing storage update information as a result of application processing in a volume provided by a memory area of the memory apparatus, and exchanges information with a mobile terminal or a host computer via a communication network,
wherein the storage control unit includes plural volume update patterns indicating storage destination candidates for the storage update information, wherein, when performing volume merge in which local update information input from the mobile terminal or host computer and the storage update information is reflected in relevant volumes, the storage control unit selects a volume change pattern for a storage destination different from a storage destination for the local update information from among the plural volume update patterns, wherein the storage control unit stores the storage update information in a storage area corresponding to the selected volume update pattern, and wherein the storage control unit transfers the storage update information to the mobile terminal or host computer together with information showing the storage destination for the storage update information.

2. The storage subsystem according to claim 1, wherein the storage control unit compares the local update information with the storage update information when performing the volume merge, and wherein, when storage destinations for both the pieces of update information overlap, the storage control unit selects a volume change pattern for a storage destination different from a storage destination for the local update information from among the plural volume update patterns.

3. The storage subsystem according to claim 1, wherein the storage control unit inputs processing information, which results from processing executed by an application server connected to the communication network, as the storage update information.

4. A storage subsystem comprising:
a memory apparatus being composed of plural memory devices; and
a storage control unit storing storage update information as a result of application processing in a volume provided by a memory area of the memory apparatus, and exchanges information with a mobile terminal or a host computer via a communication network,
wherein, when performing volume merge in which local update information and the storage update information are reflected in relevant volumes, the storage control unit stores the storage update information in a storage area serving as a storage destination different from a storage destination for the local update information, and wherein the storage control unit transfers the storage update information to the mobile terminal or host computer together with information showing the storage destination for the storage update information.

5. A storage subsystem comprising:
a memory apparatus being composed of plural memory devices; and
a storage control unit storing storage update information as a result of application processing in a volume provided by a memory area of the memory apparatus, and exchanges information with a mobile terminal or a host computer via a communication network,
wherein the storage control unit, when performing volume merge in which local update information and the storage update information are reflected in relevant volumes, stores the storage update information in a file system different from a file system not serving as a storage destination for the local update information.

6. A storage system comprising:
a storage subsystem storing storage update information as a result of processing of an application in a volume provided by a memory area of a memory device; and
a mobile terminal storing local update information as a result of terminal processing in a local volume having a storage area corresponding to the volume and exchanges information with the storage subsystem via a communication network,
wherein the storage subsystem includes plural volume update patterns indicating storage destination candidates for the storage update information, wherein, when performing volume merge in which the local update information and the storage update information are reflected in relevant volumes, the storage subsystem selects a volume change pattern for a storage destination different from a storage destination for the local update information from among the plural volume update patterns, and wherein the storage subsystem stores the storage update information in a storage area corresponding to the selected volume update pattern, and
wherein, when performing the volume merge, the mobile terminal stores the storage update information in a storage area in the local volume, which corresponds to the storage area for the storage update information in the storage subsystem.

7. The storage system according to claim 6, wherein the storage subsystem compares the local update information with the storage update information when performing the volume merge, and wherein, when storage destinations for both the update information overlap, the storage subsystem selects a volume change pattern serving as a storage destination different from a storage destination for the local update information from among the plural volume update patterns.

8. The storage system according to claim 6, further comprising an application server being connected to the storage subsystem via the communication network, wherein the application server accesses the storage subsystem, executes the application, and transfers processing information as a result of the execution of the application to the storage subsystem as the storage update information.

9. A storage system comprising:
a storage subsystem storing storage update information as a result of processing of an application in a volume provided by a memory area of a memory device memory device; and
a mobile terminal storing local update information as a result of terminal processing in a local volume having a storage area corresponding to the volume and exchanges information with the storage subsystem via a communication network,
wherein, when performing volume merge in which the local update information and the storage update information are reflected in relevant volumes, the storage subsystem stores the storage update information in a storage area serving as a storage destination different from a storage destination for the local update information; and
wherein, when performing the volume merge, the mobile terminal stores the storage update information in a storage area in the local volume, which corresponds to the storage area for the storage update information in the storage subsystem.

10. A storage system comprising:
a storage subsystem storing storage update information as a result of processing of an application in a volume provided by a memory area of a memory device memory device; and
a mobile terminal storing local update information as a result of terminal processing in a local volume having a storage area corresponding to the volume and exchanges information with the storage subsystem via a communication network,
wherein, when performing volume merge in which the local update information and the storage update information are reflected in relevant volumes, the storage subsystem stores the storage update information in a file system different from a file system not serving as a storage destination for the local update information.
